(19) United States
(12) Patent Application Publication
(10) Pub. No.: US 2002/0060132 A1
(43) Pub. Date: May 23, 2002

(54) Workpiece transport apparatus

(76) Inventors: Michael Richard Kloster, Surrey (CA); Bernard Martin Brady, Surrey (CA)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 10/041,530

(22) Filed: Jan. 7, 2002

Related U.S. Application Data
(63) Continuation of application No. 09/273,305, filed on Mar. 19, 1999.

(51) Int. Cl. B27C 5/02

(52) U.S. Cl. 198/485.1; 198/803.14; 144/245.6

(57) ABSTRACT

Anti-jam J-bar structure for handling workpieces, such as lumber, in a workpiece transport system, such as a lumber sorter. Workpieces travel in a single, common flow direction in the system, and are handed-off through a transfer zone between upstream and downstream conveyors, the latter one of which is equipped with the proposed J-bar structure. The J-bars in this structure include spring-biased, pivoted articulation between inner and outer components, and this articulation allows anti-jam yielding and accommodation to occur should a J-bar inadvertently and incorrectly engage a workpiece.

### CROSS-REFERENCE TO RELATED APPLICATION

This application is a continuation of U.S. patent application Ser. No. 09/273,305 filed Mar. 19, 1999 entitled “Workpiece Transport Apparatus”, which application is hereby incorporated by reference.

### BACKGROUND OF THE INVENTION

This invention pertains to workpiece transport apparatus, and in particular, to apparatus which is designed specially to yield, by moving out of the way (in a manner of speaking), in a forgiving manner under circumstances of several particular kinds of jamming events which tend to plague certain kinds of workpiece transport systems. While we recognize that a system including devices that are made in accordance with our present invention may take a variety of different forms designed to handle different kinds of workpieces, the invention, as the same is described hereinbelow, is pictured and discussed in the context of what is known, in the lumber-manufacturing field, as a J-bar lumber sorter—a system in which the invention has been found to offer particular and immediate utility, including, significantly, retrofit utility.

### TECHNICAL FIELD OF THE INVENTION

In the lumber-manufacturing industry, and with respect to the J-bar sorting system employed herein, it is very common to have a given, single saw mill arranged in such a manner that substantially 100% of its throughput product “merges” at the end of processing (so-to-speak) into a region where it is fed, in its output-entirety, through a single J-bar sorting machine which collects individual workpieces (sticks of lumber) one-by-one, and feeds them in outbound fashion for sorting into particular, pre-selected categories of boards. For example, sorting may be accomplished to achieve differentiation based upon size (length and cross section), based upon grade, and perhaps based upon any one of the number of other categorizations. To maximize throughput efficiency, it is desirable that changes in the direction of travel of workpieces in the sorter system be minimized.

Thinking about this kind of setting, and further describing generally how it can be pictured, successive pieces of lumber, referred to herein as workpieces, are transported in a defined direction, a single, common direction throughout, by a motion element, or elements, in what can be thought of as a relatively high-speed hand-off conveyor, toward and into a hand-off load station, or transfer zone, wherein the intention is that, piece-by-piece, and in proper timed succession, individual boards, still moving in the same (common) direction, are collected by a J-bar sorter of the type just generally mentioned above. By operation of this sorter, such J-bar-collected boards are carried, also still in the same, common direction, for deposit into different collection stations (bins, for example), in accordance with a particular selected categorization protocol. In the specific transfer zone wherein each workpiece is handed off to a J-bar sorter, boards are fed into this zone at a relatively high speed to the intake end of the J-bar sorter, which collects these boards and carries them at a considerably lower speed for sorting. The J-bar sorter takes the form of a plural, power-driven chain conveyor wherein the chains (motion elements) carry plural, spaced, elongate, outwardly extending J-bars which lower into the transfer zone to become positioned to receive successive workpieces. The mentioned speed differential is conventionally employed in order to obtain confirmed and positive handoff of boards in an orderly, predictable and confident manner. Put another way, the mentioned speed differential is employed, inter alia, in order to be certain that transfer takes place with dispatch and precision.

Under these circumstances, it will be very evident that it takes only a slight malfunction during hand-off to create a very serious and invasive bottleneck to the desired orderly, and speedy, common-direction throughput of materials. Such a bottleneck makes itself very disturbingly evident when a malfunction requires that the J-bar sorter be shut down for a period of time so that unjamming can be done, and repairs made. A typical jamming event occurs where lowering of a J-bar into a position in the transfer zone to gather a workpiece causes that J-bar to come down on top of a workpiece, rather than appropriately somewhat downstream of the workpiece.

Further describing a typical J-bar sorter, such a machine usually takes the form of a plurality of side-by-side adjacent, spaced, endless, band-like, power-driven chains (a transport drive mechanism, or device) which carry (in a continuous circuit) outwardly projecting or extending groups of J-bars. Each chain carries a plurality of these J-bars, and it is typical that successively adjacent J-bars which are distributed along a given single chain are spaced apart by a distance of about three feet. Further, typical J-bar sorters include somewhere in the range of about two to about eight, side-by-side chains.

The usual construction for a J-bar in such a system, usual that is for the past several decades, is a unitary and rigid construction of an element which can be thought of as possessing a J-shape or an L-shape, the “open” workpiece-receiving side in which is moved by the respective, associated carrying chain downwardly into and then horizontally through a workpiece transfer zone of the type mentioned above. The chains in a sorter of this type are effectively locked to one another for driving as a unit, in a manner whereby the carried projecting J-bars march, if you will, as in military unison to form a laterally extending row (actually successive rows) that presents itself for appropriate collection of successive delivered elongate boards. Proper operation dictates that each successive row of J-bars lower into the transfer zone substantially fully, and in a precise position placing the J-bars slightly downstream and initially out of contact with a traveling workpiece which is to be collected by the row.

Operation of a J-bar sorter and of its upstream associated hand-off mechanism is normally performed under tight precision computer control so that the timing of events, i.e. the timing that relates to when a row of J-bars is properly positioned for collection of the next successive delivered board, is substantially perfect—perfect in the sense that the J-bars are precisely in positions slightly downstream to collect that board when that board is advanced by the upstream, higher-speed conveyor to a position to be collected.

Two kinds of serious “jamming” conditions, one of which was mentioned briefly above, frequently occur in this traditional setting, and it is these jamming conditions which have presented severe downtime problems with prior apparatus (rigid J-bar structures), and which have posed other problems. One of these conditions (the one mentioned above), and the one which is probably the most prevalent, involves what occurs improperly at the location of the transfer hand-off of successive boards to a J-bar sorter. Specifically, the condition which produces a harmful jam arises when a board is presented for collection a little bit too early, which “too-early” delivery results in one or more of the projecting J-bars lowering downwardly onto, striking and driving into such an early-delivered board before it/they have reached the appropriate downstream hand-off positions. This condition, in the past, has frequently caused J-bar breakage and transport interruption (jolting interruption) in the J-bar system.

Obvious consequences have included necessary downtime to effect repairs, costs associated with implementing repairs and in buying and installing replacement J-bar structures, and additionally, very serious risk of injury to employees who must enter the jammed area to clear it and to remove and replace broken J-bars. The danger presented to such personnel, inter alia, results from the typical requirement that a saw mill worker enter the jam area with a power chain saw to cut away the jamming and offending stick of lumber, and to perform this activity in an environment where it is difficult to move, and wherein support footings are not as one would find out on solid ground.

The problems just now described above in connection with use and operation of a typical J-bar sorter have been around for decades, and it is in the setting particularly of addressing this age-old, worrisome concern that the present invention has had its principal focus.

A very simple way of thinking fundamentally about what is offered by the present invention is to observe that it proposes the building and use in a J-bar sorter of a specially-modified, articulated version of a typical (otherwise) J-bar element, with this new kind of J-bar element being formed with one elongate straight component that is anchored (non-pivoted) directly to a drive chain (motion element) in a J-bar sorter, a second element which is somewhat L or J shaped pivoted to the outer end of the first-mentioned component at a location outwardly spaced from the associated chain motion element, and an interconnecting jacket through which these two components are joined. Part of this joint includes a transverse pivot axis which allows the second-mentioned component to pivot in a defined way relative to the first-mentioned component, with pivoting occurring about a pivot axis that is afforded through the jacket just mentioned. The mentioned jacket pivots as a unit with second component, and confronting engagement between the jacket and the first-mentioned J-bar component limits relative pivoting in one direction, and defines a normal deployed condition for the overall J-bar structure. With the pivot axis for the “second” component being spaced from the chain motion element to which the first component is securely anchored to work as a unit with that motion element, substantial swing-pivoting of the second J-bar component is permitted to avoid substantially all usually previously encountered jamming events.

Further there is present, according to the invention, a tension-biasing spring which permits what is referred to herein as yielding relative motion to occur between these two components. This motion is reversible under the influence of the build-up of tension in the biasing spring once a particular J-bar structure, of our new type, has “cleared” the offending, potentially jamming stick of lumber. The spring-resisted, limited pivoting capability, around a transverse axis which is spaced outwardly of the associated J-bar-carrying chain, is what obviates a jamming condition.

An important consequence of use of the device of the present invention is that many, if not most, of the kinds of previously experienced hand-off jamming events are accommodated by the mentioned pivoting yield motion in our new J-bar structure so that (a) machine down time is not encountered, (b) J-bar damage and replacement does not occur and is not required, and (c) personnel safety is not challenged by the requirement that someone enter a jam area with dangerous equipment to relieve a jammed condition.

Importantly, the device produced in accordance with the present invention is relatively simple in construction, can be built relatively inexpensively, and can be retrofitted readily into existing J-bar sorter machines.

A jamming event which can also occur sometimes (the other condition referred to earlier), and which is also addressed by the structure of the present invention, is one wherein, even after a board is collected and is being transported normally, an earlier predecessor board has not been successfully delivered to its sorting reception area and, in the bargain, is in fact sifting in the way of progressive motion of oncoming J-bar structures which can then bump downwardly into that piece of lumber to promote a jamming condition often equally as harmful as the one first described. The spring-biased pivoting articulation offered by the present invention, which articulation clearly substantially fully solves a jamming condition in the transfer zone discussed earlier, operates in substantially the same fashion with respect to this second-mentioned kind of jamming condition to minimize its potential negative affect on plant operation.

Accordingly, the structure of the present invention offers a number of significant advantages over conventional, related predecessor structures, and the various opportunities and advances proffered by the invention will become more clearly apparent as the description which now follows is read in conjunction with the accompanying drawings.

### DESCRIPTION OF THE DRAWINGS

FIG. 1 is a simplified and very schematic side elevation showing, somewhat fragmentarily, a lumber mill employing a J-bar sorter system which has been equipped with J-bar units or devices that are built in accordance with the present invention.

FIG. 2 is a substantially enlarged, and also fragmentary, side elevation generally picturing, from within the area embraced by the two curved arrows marked 2-2 in FIG. 1, one of the devices carried in the J-bar sorter pictured in FIG. 1—this device being built in accordance with the present invention.

FIG. 3 is a somewhat enlarged, fragmentary cross section taken generally along the line 3-3 in FIG. 2.

FIG. 4 is a fragmentary plan view, presented generally on the same scale as that employed in FIG. 3, looking downwardly in the plane of FIG. 2 immediately over the location of the chain-mounted device pictured in FIG. 2.

FIG. 5 is a fragmentary, simplified and somewhat schematic view picturing, with a slightly larger scale than that which has been employed in FIG. 1, elements in the J-bar sorter shown in FIG. 1, with particular emphasis being given in this figure to certain performance activities that take place adjacent the opposite ends of the elongate J-bar system pictured.

FIG. 6 is a view, on a somewhat larger scale than that employed in FIG. 5, illustrating, in a kind of story-telling fashion, operational events that take place in the region which is pictured at the left side of FIG. 5. Particular emphasis is given in this figure to show several moved-position views to illustrate hand-off transfer activity.

FIG. 7 is very similar to FIG. 6, differing in that it illustrates, with moved positions employed, the onset and occurrence of a transfer zone jamming event which is typical in plants employing conventional J-bar systems, and which is dealt with successfully by the anti-jam yield behavior that is offered by the present invention.

FIG. 8A is a fragmentary and somewhat schematic detail, pictured on about the same scales employed in FIGS. 6 and 7, illustrating response by a device constructed in accordance with this invention to what was mentioned earlier as the second-mentioned type of potential conventional jamming activity. Here, too, this potential jamming event is averted because of the way in which the present invention performs.

FIG. 8B, drawn on a scale which is slightly larger than that employed in FIG. 8A, is taken generally from the point of view looking into the area embraced by the two curved arrows shown at 8B-8B in FIG. 8A, and specifically demonstrating a very large angle yield articulation (i.e., an anti-jam articulation) which can be performed in accordance with the construction of the present invention.

FIG. 9 is a fragmentary perspective view on a scale which is slightly larger than the scales that are used in previously described FIGS. 2, 3, and 4, showing what can be thought of, generally, as a central portion (i.e., between opposite ends) of a device, also referred to herein as a transport instrumentality or as a transport arm, constructed in accordance with the present invention, and with components in the arm being pictured here under circumstances wherein they reside, relative to one another, in what is referred to herein as a nominal undisturbed, deployed operating condition.

FIG. 10 is a fragmentary cross section through the portion of a device pictured in FIG. 9, and taken generally in the plane wherein, or so one can think of it, yield articulation takes place in accordance with the present invention. In FIG. 10, the various component parts which make up a single device constructed in accordance with the present invention are shown in the same nominal undisturbed, deployed operating condition pictured in FIG. 9.

FIG. 11 is very much like FIG. 10 except that it illustrates a condition of spring-resisted yield articulation.

### DETAILED DESCRIPTION, AND BEST MODE OF CARRYING OUT, THE INVENTION

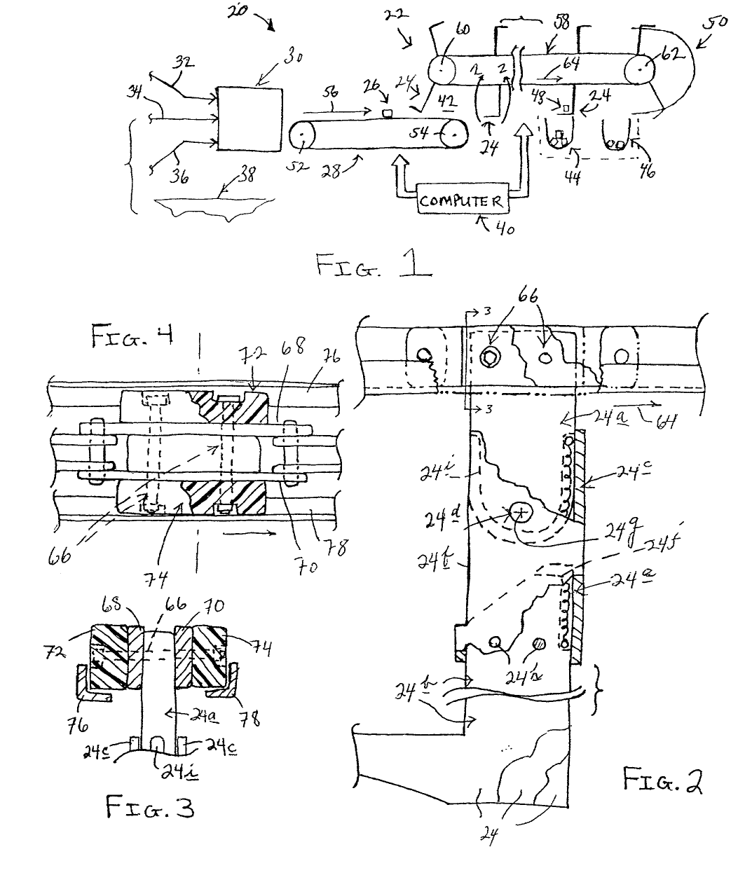

Turning attention now to the drawings, and referring first of all to FIG. 1, indicated generally at 20 is apparatus which is employed in a generally conventional lumber saw mill, which apparatus includes a J-bar sorter system 22, also referred to herein as a workpiece transport system, which carries plural J-bar structures, such as structures 24 that are constructed in accordance with the present invention, in what is referred to as a transport motion. Lumber, or workpiece, motion in apparatus 20 has a common, generally horizontal flow direction throughout, and that motion is from left to right in FIG. 1. In the particular mill which is pictured partially in FIG. 1, sorter 22 is the only and the single lumber sorter employed by the mill, and this sorter receives, for sorting purposes, successively delivered, elongate boards or workpieces, such as the single board shown at 26 in FIG. 1, by way of a transfer and hand-off conventional upstream conveyor 28, which is also referred to herein as a source of workpieces. Conveyor 28, by way of suitable and conventional “upstream” processing apparatus, depicted generally by the block shown at 30, receives successive boards, such as board 26, which have emerged from, in the instance now being described, a variety of predecessor processing areas in the plant, with several such predecessor areas being pictured by the three arrows shown at 32, 34, 36 in FIG. 1. All of the equipment so far mentioned in the plant partially and schematically illustrated in FIG. 1 sits appropriately upon the plant floor which is shown fragmentarily at 38 in FIG. 1. Conveyor 28 and sorter 22 have their operations controlled and appropriately coordinated in a conventional manner by a conventional, programmed digital computer which is shown generally at 40 in FIG. 1.

Further describing what is generally pictured in FIG. 1, successive workpieces delivered, as will shortly be more fully described, to sorter 22 are handed off from left to right to the sorter generally at the location of a transfer zone illustrated at 42. From this transfer zone, workpieces are conveyed, in the consistent common transport direction mentioned above toward appropriate sort destinations, such as the two destination collection bins which are illustrated at 44, 46 in FIG. 1. Bin 46 is downstream relative to bin 44, and pictured immediately above bin 44 is a transport J-bar element 24 which forms part of a row of J-bar transport elements (as will soon be elaborated) which is shown, in a very simple manner, to be carrying a board 48.

Illustrated at a location downstream from bin 46 in FIG. 1, and wrapping, in a sense, upwardly around the right end of sorter 22, are plural guide rails, one of which is shown generally at 50, that function, under certain circumstances which will also shortly be described, to return (for sorting processing) any errant board which escapes being delivered as a sorted element in its first pass through and by the sorter, and which makes it way to the right end of the sorter in FIG. 1.

Conveyor 28 herein takes the form of a multiple gang-driven chain conveyor which is pictured, in a simplified form in FIG. 1, with its chains being trained over a pair of idler and/or drive pulleys 52, 54. These pulleys transport the chains generally in a direction (relative to the upper run of the chains) indicated by arrow 56 (the common workpiece transport direction in the system), in such a manner that boards are delivered successively, one after another to transfer zone 42.

Sorter 22 includes ganged multiple drive chains, such as the chain pictured generally at 58 in FIG. 1, and these chains are trained around idler and/or drive pulleys, such as the two shown at 60, 62 in FIG. 1. This collective structure is referred to herein as a downstream conveyor. In the particular sorter now being described, eight of these chains are employed, and these chains are driven in a manner whereby their elongate straight runs travel generally, as indicated by arrow 64 in FIG. 1, in what can be thought of as a counterclockwise direction in this figure. Arrow 64 points in the direction of the common workpiece transport direction in the system, and is pictured in FIG. 1 as being significantly shorter than arrow 56. This difference in length has been employed to emphasize the presence of a linear transport speed difference between conveyor 28 and sorter 22.

Each chain in sorter 22 carries a plurality of transport elements (J-bars) constructed in accordance with the present invention and spaced along the length of each chain with an inter-J-bar spacing (nominally) of about three-feet. From the point of view which is pictured in FIG. 1, the J-bars which are joined to the eight different chains are essentially aligned in rows extending generally normally into the plane of FIG. 1, and the J-bars in a given row effectively move as a unit with operation of the chains in sorter 22. As will be discussed further, these J-bars, and more specifically the successive rows of J-bars, which are moved downwardly into and then horizontally through transfer zone 42 do so, if everything is operating correctly, under the control of computer 40, in such a manner that they are positioned (as a row) to receive a single board appropriately “simultaneously” presented (slightly upstream) for delivery in zone 42. In FIG. 1, board 26 is about to enter zone 42, and is about to be collected, if everything works appropriately, by the row of J-bars, the near one of which is pictured overlying and lowering toward the right ends of the chains in conveyor 28 in FIG. 1.

As those skilled in the art in this field will recognize, what can be thought of as the longer stretches of J-bars 24 in FIG. 1, i.e., those stretches which appear to extend directly and somewhat normally outwardly, from the respective supporting chains, are ultimately positioned generally vertically in station 42. Outer extremity extensions in these J-bars, pictured as existing and typically disposed at an angle of about 90-degrees to the other portions of the J-bars, lie in a generally horizontal plane in zone 42, which plane is appropriately located so as to position these outer end extensions to receive a board, such as board 26 from conveyor 28. If all goes well with this hand-off operation, that board is collected and is moved by the transport J-bars in sorter 22 to the right in FIG. 1 over the various sorter bins, such as bins 44, 46. The board is appropriately and conventionally delivered to the correct one of these bins at the appropriate time.

As was mentioned earlier, probably the most significant problem of jamming which is addressed by the present invention is a problem which arises in zone 42 under circumstances where a board, such as board 26, is presented for collection “too early” in relation to the lowering into zone 42 of the next successive row of J-bars, such as J-bars 24. As was also mentioned earlier, where J-bars of a conventional design are employed, as they are ubiquitously today throughout the world of saw mill plants, a mis-timed delivery and hand-off operation, such as the one just briefly described, can cause one or more of these J-bars arms effectively to land upon and strike an early-delivered board with resultant severe breakage and work stoppage, later to be followed by unwanted, costly and dangerous repair, replacement and downtime. Employment of articulated J-bars constructed in accordance with the present invention substantially eliminates the negative effects of such a jam condition by not allowing it to occur.

Each J-bar 24, constructed herein in accordance with the present invention, has a structure, preferably, such as that illustrated especially well in FIGS. 2-4, inclusive, and 9-11, inclusive. Accordingly, the reader's attention is now directed to these six drawing figures which should now be considered along with just-discussed FIG. 1. FIGS. 3, 4 and 9-11, inclusive, picture, fragmentarily, a single J-bar 24. FIG. 2 illustrates three J-bars 24 which lie in a common row of J-bars aligned in side-by-side relative adjacency on the various several chains employed in the conveyor in sorter 22. These three J-bars, of the eight which are actually present in each row of J-bars in sorter 22, are pictured by using the drawing technique of partial fragmentation (appearing at the lower side of FIG. 2) which fragmentation breaks away nearer J-bars to show more distant J-bars. The construction of each such J-bar is identical to that of each other J-bar according to the present invention, and it is this commonly shared construction which is pictured and which will now be described with reference to the six figures (beyond FIG. 1) which were just called out for attention above.

Each J-bar 24 includes an elongate, and generally straight and linear upper component 24a referred to as a first component, a lower, somewhat “right-angularly” formed second elongate component 24b, an interconnecting jacket 24c (part of a limit structure) which is anchored (as will be explained) to component 24b, and which is pivoted, via a pivot pin 24d, to the lower free end of component 24a in FIG. 2. Also included is a biasing spring 24e which is under tension, and which acts between, and has its opposite ends appropriately anchoredly connected to, components 24a, 24b.

The upper and lower (or inner and outer) components 24a, 24b are preferably formed by any appropriate manner of a suitable relatively lightweight plastic material, and jacket 24c is preferably made of a metal such as steel.

The upper end of elongate J-bar 24, as it is pictured in FIGS. 2-4, inclusive, is anchored (though selectively removably) to function as a unit with a chain motion element (such as a link) in sorter 22 through the use of two nut and bolt assemblies, such as assemblies 66. Very specifically, the upper end of component 24a in these three figures is positioned intermediate two spaced, side-by-side adjacent chain links (motion elements) 68, 70 which form part of the drive chain in sorter 22. Disposed on the outwardly facing sides of these two links, and anchored in place along with upper component 24a, are two outwardly positioned nylon guide blocks 72, 74 which have appropriately outwardly facing wells that receive in recessed fashion, the opposite ends of previously mentioned nut and bolt assemblies 66. These blocks ride appropriately within the construction of system 22, and along both the upper and lower runs of the conveyor chains, in pairs of laterally spaced angle iron guides such as the two guides shown at 76, 78 in FIGS. 2-3, inclusive. The links just mentioned in the drive chain discussed with reference to these links in sorter 22 are entirely conventional in construction, and are pivotally joined to adjacent sets of links in the usual conventional arrangement. Nut and bolt assemblies 66 permit ready installation, and if necessary, removal, of a J-bar, such as bar 24.

Jacket 24c has a generally elongate rectilinear hollow cross section which fits conveniently around the confronting portions of components 24a, 24b, with this jacket including, on its left side as pictured in FIG. 2, an elongate upper open stretch, such as stretch 24f which faces openly and to the left in FIG. 2. Pin 24d allows hinging, swinging or pivoting motion of jacket 24c and component 24b as a unit about a pivot axis 24g which is coincident with the long axis of pivot pin 24d. This axis is normal to the plane of FIG. 2, is contained in the plane of FIG. 4, and is spaced outwardly from the chains in sorter 22.

The lower part of jacket 24c is anchored as by riveting (or bolting) as shown to component 24b using two attaching arrangements such as those shown at 24h. As a consequence of this interconnection, jacket 24c and component 24b act as a unitary structure.

Formed generally along the lower side of component 24a in FIG. 2, generally centrally between the opposite faces of this component as such are viewed in planes paralleling the plane of FIG. 2, it is a generally U-shaped channel 24i, the right side of which in FIG. 2 is seen receiving the upper end of biasing spring 24e, which upper end is suitably anchored within the upper stretch of the right-hand side of this channel to the body of component 24a. Suitably provided in the upper and right-hand sides of component 24b, as such is pictured in FIG. 2, is a somewhat similar central channel in the upper and right sides of this component, with this second-mentioned channel being pictured at 24j. The lower end of biasing spring 24e in FIG. 2 is appropriately anchored to the body of component 24b within and near the lower end of channel 24i as such is pictured in FIG. 2.

In FIG. 2, components 24a, 24b, are illustrated in what has and will be referred to herein as a nominal undisturbed operating condition (a deployed condition). Under these circumstances, biasing spring 24e lies substantially along an upright straight line. Jacket 24c has a portion engaged with the right side of component 24a in FIG. 1 and this component side forms another portion of the limit structure mentioned earlier.

Significantly, this J-bar structure which has just been described is one which permits yieldable-swinging angular motion as an important type of relative motion between components 24a 24b. It is specifically the illustrated and described constructions and locations of jacket 24c, pivot pin 24d and biasing spring 24e which permit this kind of important yield motion that is offered by the present invention. Jacket 24c, pivot pin 24d and biasing spring 24e collectively constitute interconnect structure herein.

Continuing with reference especially to FIGS. 2-4, inclusive, and FIGS. 9-11, inclusive, the right side of component 24b in FIG. 2 is one which can be thought of as facing downstream relative to the direction of workpiece transport motion pictured by arrow (herein previously mentioned) 64. The other side of component 24b constitutes the workpiece engagement side of the J-bar, and is the side which faces and receives oncoming delivered boards from conveyor 28.

Given the articulation structure and the J-bar component structure which has just been described, and viewing especially FIG. 2 for a moment, it will be very clear that relative swinging between components 24a, 24b, in the sense of component 24b swinging on pivot axis 24g in a counterclockwise direction in FIG. 2, is prevented because of the way, particularly, in which the upper region of jacket 24e engages the right side of component 24a in this figure. However, clockwise relative swinging of component 24b relative to component 24a, and on pivot axis 24g, is readily accommodated, throughout a quite wide angle (herein about 135-degrees), against the “returning” tension or resistance activity of biasing spring 24e. In a condition with a J-bar extending downwardly in FIG. 2, such permitted “clockwise” swinging causes component 24b effectively to swing in a translational direction which is opposite the earlier mentioned workpiece transport direction. It is this constructional and operational result of an articulated J-bar built in accordance with the present invention which offers the important anti-jam performance that has been mentioned and highlighted herein. More specifically, when something occurs that effectively causes the right, transport-direction-facing side of component 24b in FIG. 2, to engage something, typically a mis-positioned board, during lowering of the J-bar into the transfer zone, the pivot interconnection and the return biasing spring provided cause yield-swinging to occur for component 24b, which swinging allows the component, as a whole, to “walk past” the offending board and to prevent, under most circumstances, any damaging activity, such as breakage and downtime. As was just above mentioned, this spring-resisted swinging is seen to occur in a direction which is essentially opposite the direction of travel of the chain in sorter 22 which carries the J-bar.

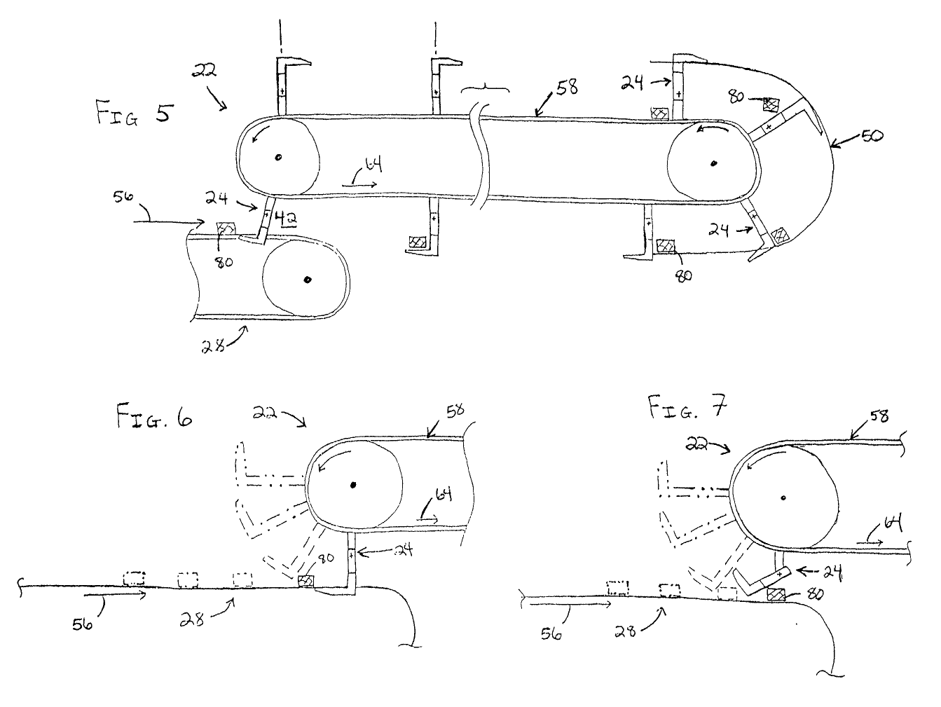

Referring now to FIGS. 5-8B, inclusive, and looking first of all to the activities especially pictured at the left side of FIG. 5 and FIG. 6, if all is working smoothly with respect to the manners in which successive boards are presented and handed off to sorter 22, hand-off activity in relation to the J-bars in sorter 22 is handled in a very normal fashion. In FIG. 6, four different positions of a J-bar 24 and of a deliverable board 80 are pictured. Under the influence of conveyor 28, board 80 approaches zone 42 from the left to the right in FIG. 6, passing successively through positions which, in order, include the dash-double-dot position to the extreme left side of FIG. 6, later to the dash-dot position, shortly thereafter to the dashed-line position, and finally to the solid-line position which is the correct transfer position intended for hand-off in station 42. J-bars 24 thus lower into zone 42.

This is a normal non-jam inducing situation, and board 80 is thus collected normally for transfer by sorter 22. In relation to this activity, one should note that FIG. 5, at its left side, pictures the relative positions of these components just immediately prior to placement of board 80 into the collection position pictured in FIG. 6. The collecting set of J-bars in the sorter is just slightly downstream from board 80.

If all continues to be operating well and normally, board 80, as will be true for any other board so properly handled, will be collected and transported by sorter 22 and dropped off at the appropriate bin.

If, however, something goes awry with respect to delivery timing of a board in zone 42, and specifically, if this mis-timing results in a potential jamming condition, the articulation feature offered by the present invention helps to solve this problem, and this is illustrated especially in FIG. 7. One will note that what is shown in FIG. 7 has a very strong relationship to what is shown in FIG. 6, with the important difference being that board 80 has, for some reason, been presented to zone 42 before it should have been presented to this zone. This might, for example, occur because of some upstream happening which has resulted in the board being further along the upper run of the chains in conveyor 28 than it should be. A result of this “out-of-position” delivery of aboard 80 is that board arrives at the appropriate collection position in zone 42 in advance of the J-bars which, now lowering, are intended to collect the board. This condition is pictured clearly in FIG. 7. By a comparison of the events shown in FIG. 7 with those pictured in FIG. 6, one can see how the early delivery condition for board 80 will result in its not being positioned for proper collection, but rather being positioned to engage the lower components of the lowering J-bars in a manner which, if these components could not yield, would result in a damaging, jamming operation. Yielding to accommodate this misfit in timed delivery, by way of swinging articulation of the affected wrongly engaged outer J-bar components, is pictured in FIG. 7 in a manner which should illustrate clearly how the apparatus of the invention can, in effect, cause a J-bar to walk past an improperly delivered board, and not permit a damaging jam situation.

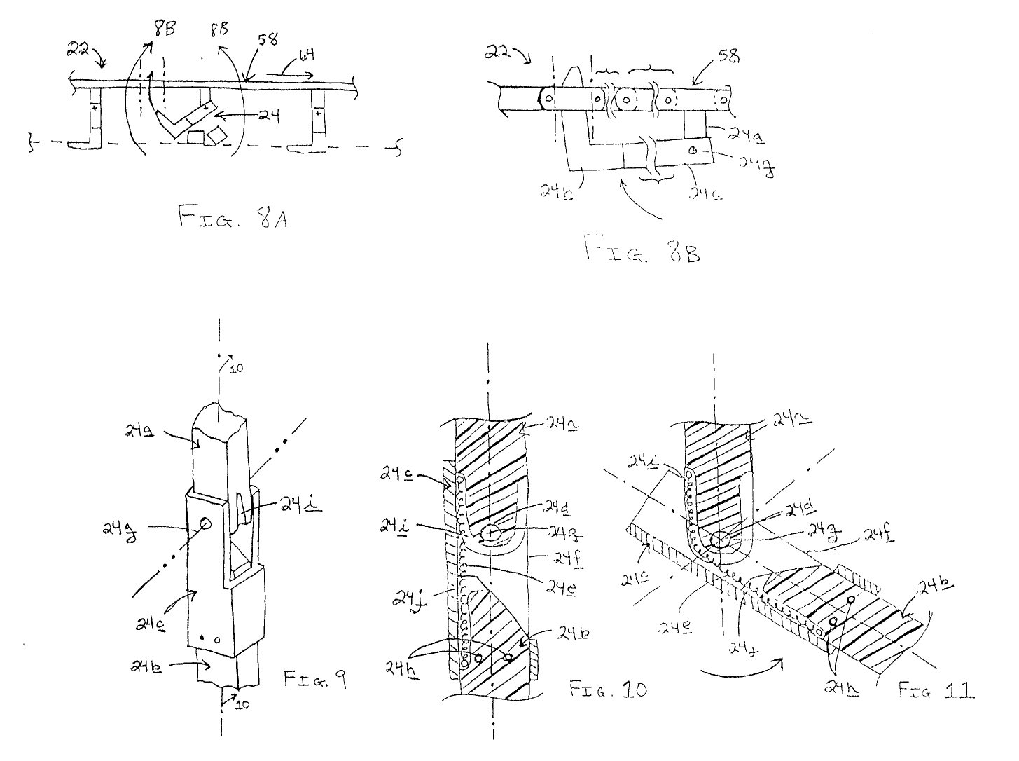

FIGS. 8A and 8B further illustrate how the structure of the present invention can handle another kind of potential jam situation, and namely one wherein an earlier properly handled board, for some reason, gets hung up in the process of being delivered to a sorting bin, and remains in the transport travel path of the next oncoming row of the J-bars. Yield activity which causes the apparatus of the present invention to avoid this kind of a jam situation is here pictured, and FIG. 8B points out the fact that a fairly large jamming object can drive the affected outer J-bar components into substantial yield swinging to accommodate non-jamming passage, with these outer components in fact swinging substantially into conditions where the outer tips or extremities of these components extend conveniently and clearingly into a space existing between a pair of nearby links in the relevant chain in sorter 22.

Finally, the right side of FIG. 5 illustrates what can happen with respect to the guide rails mentioned earlier in conjunction with FIG. 1, such as referenced guide rail 50. Here what is illustrated is an event where a downstream previously handled board has missed being delivered anywhere along the length of sorter 22, it is not precisely in a condition or situation to cause a jam, but nevertheless, does sit, so-to-speak, in the path of travel of J-bars. These J-bars which are affected, effectively collect this board and drive it upwardly and along these guide rails, such as rail 50, in a manner substantially carrying the errant board over and onto the top run of the chains in sorter 22 in a kind of alternative manner for return to station 42. Preferably, the biasing springs which are employed in the J-bars of this invention are sized to have substantial appropriate strength or stoutness to permit this kind of return delivery over the top of sorter 22, without the J-bars articulating to a point which would cause the J-bars to fail to convey such a board in the manner illustrated on the right side in FIG. 5.

Thus, described and illustrated herein is a unique and new form of a load transport apparatus pictured in the setting of an otherwise conventional J-bar sorter, which new construction handily deals with the lion's share of previously disruptive workpiece handling jams. The invention operates in a system wherein successive workpieces flow through the system in a single, common direction. The special and particular setting described for the invention herein in a lumber mill illustrates the important utility of the present invention, and will suggest to those skilled in the art how the fundamental features and constructional aspects of the structure of the present invention may well have important utility in other fields of workpiece handling.

Clearly, the proposed structure is quite simple in construction, and equally clearly is the fact that the proposed invention structure can readily be retrofit in already pre-existing equipment.

While various features and advances that are offered and proposed by the present invention have thus been described and illustrated herein, we appreciate that various changes and modifications may be made which come within the scope of the present invention.

It is desired to claim and secure by Letters Patent:

1. In a workpiece transport system including an upstream conveyor, an adjacent downstream conveyor, and a transfer zone disposed operatively intermediate these two conveyors wherein workpieces are transferred from the upstream conveyor to the downstream conveyor, with such workpieces that are traveling in the system having a single, common flow direction on the two conveyors and through the transfer zone, the improvement comprising anti-jam, workpiece-handling J-bar structure carried on the downstream conveyor for lowering into the transfer zone as a precursor to gathering a workpiece for transport on the downstream conveyor, said J-bar structure comprising
a first elongate component having one end anchored to a motion element in the downstream conveyor, and an outwardly extending free end which is spaced from that motion element,
a second elongate component having one end disposed adjacent the free end of said first component for swinging of that second component about a horizontal axis, and a spaced free end of its own which is a workpiece-gathering end, and
interconnect structure operatively interconnecting said adjacent ends of said components, including (a) pivot structure enabling swinging of the second component relative to the first component about a generally horizontal axis which is substantially normal to the mentioned common flow direction, (b) limit structure defining one limit of relative swinging between the two components, said one limit establishing a deployed condition for the two components, and (c) a biasing spring operatively interconnecting said two components, urging the two yieldably toward said one limit, but permitting spring-resisted swinging of said second component relative to said first component away from the deployed condition, with the second component effectively so swinging in a direction which is opposite the direction of motion imparted by the downstream conveyor to said first component.
